(19) United States
(12) Patent Application Publication
(10) Pub. No.: US 2014/0244641 A1
(43) Pub. Date: Aug. 28, 2014

(54) HOLISTIC CUSTOMER RECORD LINKAGE VIA PROFILE FINGERPRINTS

(71) Applicant: WAL-MART STORES, INC., Bentonville, AR (US)

(72) Inventor: David Patterson, Berkeley, CA (US)

(73) Assignee: Wal-Mart Stores, Inc., Bentonville, AR (US)

(21) Appl. No.: 13/779,558

(22) Filed: Feb. 27, 2013

(51) Int. Cl. G06F 17/30

(52) U.S. Cl. CPC G06F 17/30705
USPC 707/737

(57) ABSTRACT

The present disclosure extends to methods, systems, and computer program products for linking customer profiles in a customer profile database. Customer profile data are transformed from text data to large, sparse bit sets. The bit sets are then clustered into clusters based on similarities between the bit sets. Evaluation and analysis of customer profiles within clusters permit linking of customer profiles that exhibit selected degrees of similarity. This technology is both fast and accurate, and it preserves confidentiality of customer information by converting text data to bit sets.

### BACKGROUND

Retailers often have databases containing many millions, even a billion or more, customer profiles. Many of these customer profiles are redundant. Two or more customer profiles could be literally identical and the retailers would not aware of it. Other profiles could be for the same person but with different addresses, telephone numbers, email addresses, or other contact information, or could contain typographical errors that would make the profiles appear different. The large size of such customer profile databases makes updating a merchant's customer profile database difficult and costly with current methods and systems.

These problems apply even with the use of computers and current computing systems, and, the prior art is characterized by several disadvantages that are addressed by the present disclosure. The present disclosure minimizes, and in some aspects eliminates, the above-mentioned failures, and other problems, by utilizing the methods, features and systems described herein. The disclosed methods, features and systems herein, provide more efficient and cost effective methods and systems for merchants to reduce redundancy and keep customer profile databases up to date.

The present disclosure extends to methods, systems, and computer program products for linking customer profiles in a customer profile database. Customer profile data are transformed from text data to large, sparse bit sets. The bit sets are then clustered into clusters based on similarities between the bit sets. Evaluation and analysis of customer profiles within clusters permit linking of customer profiles that exhibit selected degrees of similarity. This technology is both fast and accurate, and it preserves confidentiality of customer information by converting text data to bit sets, which cannot be reverse-transformed into the confidential information. The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example computer architecture that facilitates different implementations described herein; and

FIG. 3 illustrates a flow chart of an example method according to one implementation.

### DETAILED DESCRIPTION

The present disclosure extends to methods, systems, and computer program products for providing merchant database updates for new product items. In the following description of the present disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures that can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

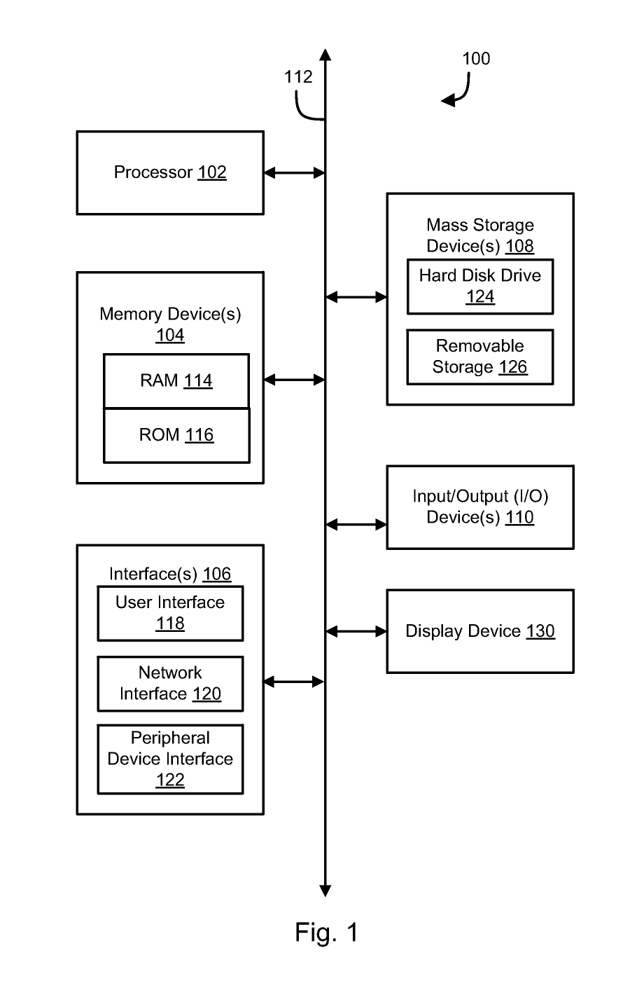

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

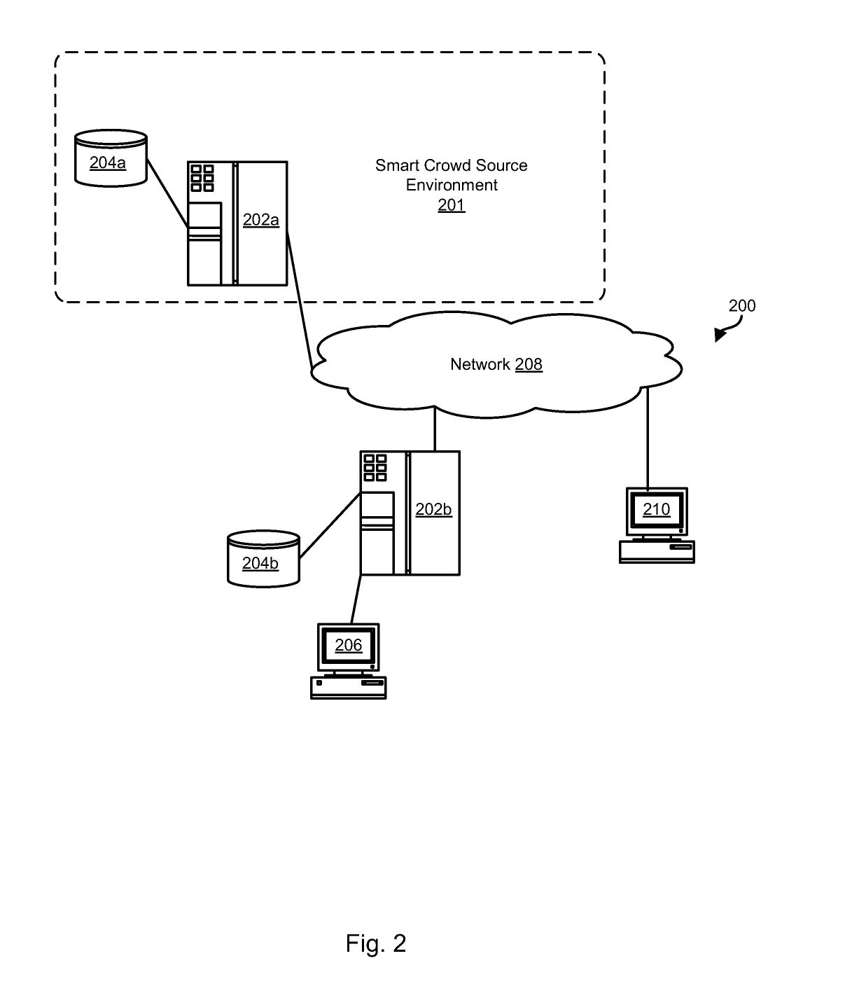

FIG. 2 illustrates an example of a computing environment 200 and a smart crowd source environment 201 suitable for implementing the methods disclosed herein. In some implementations, a server 202a provides access to a database 204a in data communication therewith, and may be located and accessed within a brick and mortar retail location. The database 204a may store customer attribute information such as a user profile as well as a list of other user profiles of friends and associates associated with the user profile. The database 204a may additionally store attributes of the user associated with the user profile. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

As used herein, a smart crowd source environment is a group of users connected over a network that are assigned tasks to perform over the network. In an implementation the smart crowd source may be in the employ of a merchant, or may be under contract with on a per task basis. The work product of the smart crowd source is generally conveyed over the same network that supplied the tasks to be performed. In the implementations that follow, users or members of a smart crowd source may be tasked with reviewing the classification of new product items and the hierarchy of products within a merchant's database.

A server 202b may be associated with a classification manager or other entity or party providing classification work. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator or customer/user may access the server 202b by means of a workstation 206, which may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

As used herein, a classification model pipeline is intended to mean plurality of classification models organized to optimize the classification of new product items that are to be added to a merchant database. The plurality of classification models may be run in a predetermined order or may be run concurrently. The classification model pipeline may require that new product items be processed by all of the classification models within the pipeline, or may allow the classification process to stop before all of the classification models are run if predetermined thresholds are not met.

It is to be further understood that the phrase “computer system,” as used herein, shall be construed broadly to include a network as defined herein, as well as a single-unit work station (such as work station 206 or other work station) whether connected directly to a network via a communications connection or disconnected from a network, as well as a group of single-unit work stations which can share data or information through non-network means such as a flash drive or any suitable non-network means for sharing data now known or later discovered.

An illustrative embodiment of the present invention comprises a method of linking customer profiles that may be the same person or may be from the same household. For the purposes of this discussion, customer profile information generally includes name and address information and may also include other information, such as telephone number, email address, and credit card information. It will be recognized, however, that other types of information could also be included in such a database. If, for example, a retailer had a customer profile database containing approximately one billion customer profiles, then there would be a significant amount of redundancy in the database since there are only about 200 million adults in the U.S. This redundancy arises, for example, when there are two different addresses associated with the same name, when there are different names associated with the same address, when there is a misspelling in a name or address, and so forth. It would be useful to the retailer to reduce redundancy, thereby reducing the size of the database and making it quicker and easier to search the database to identify individuals or households, for example.

Privacy is another element of managing customer profile databases that needs careful attention. Databases that contain sensitive information about customers, such as names, addresses, telephone numbers, email addresses, and credit card information, must be kept secure to prevent accidental access to unauthorized persons inside or outside the company. Therefore, it would be helpful to companies that maintain customer profile databases to transform the sensitive data that must be kept secure into data that can be still be used for company purposes but that cannot be reverse-transformed into the sensitive information.

A way that record linkage is typically done for identifying when multiple customer profiles are in fact the same person is first finding profile pairs that could possibly match, then narrowing those possible matches to those that seem to match, and then assembling such pairs into larger groups via graph-theoretical methods. This process inevitably results in groups of putatively identical customer profiles, some pairs of which do not match each other.

The presently described and claimed method takes a different approach, namely, by directly identifying compact clusters of potential matches. By this method, compact clusters of profiles without mismatched members can be generated. The presently disclosed method converts text data into sets of bits or profile fingerprints. This approach enables the use of analytical tools to be brought to bear on the problem of record linkage in customer profile databases. It also permits very rapid searching to find all similar customer profiles, to find the most similar customer profile, and other such applications. This has great practical value in various contexts. For some uses, the company will want to be very sure that linked profiles belong to the same person. For example, when a new profile is added to the database, it can be determined very rapidly is the new profile belongs to a person not previously found in the database or if the profile belongs to a person already having a profile in the database. This situation may arise, for example, when a retailer that sells to its customers over both the Internet and in brick-and-mortar stores, wants to determine if a new customer at a brick-and-mortar store location is the same person as or a different person from a person who previously made purchases through the retailer's web site. For other uses, such as deciding which advertisement to display on a web page when a person visits a web site, it is not necessarily important to determine that multiple profiles are associated with a single person. In such circumstances, it may be sufficient to determine that the person visiting the web site is somehow related to a particular customer profile based on certain similarities.

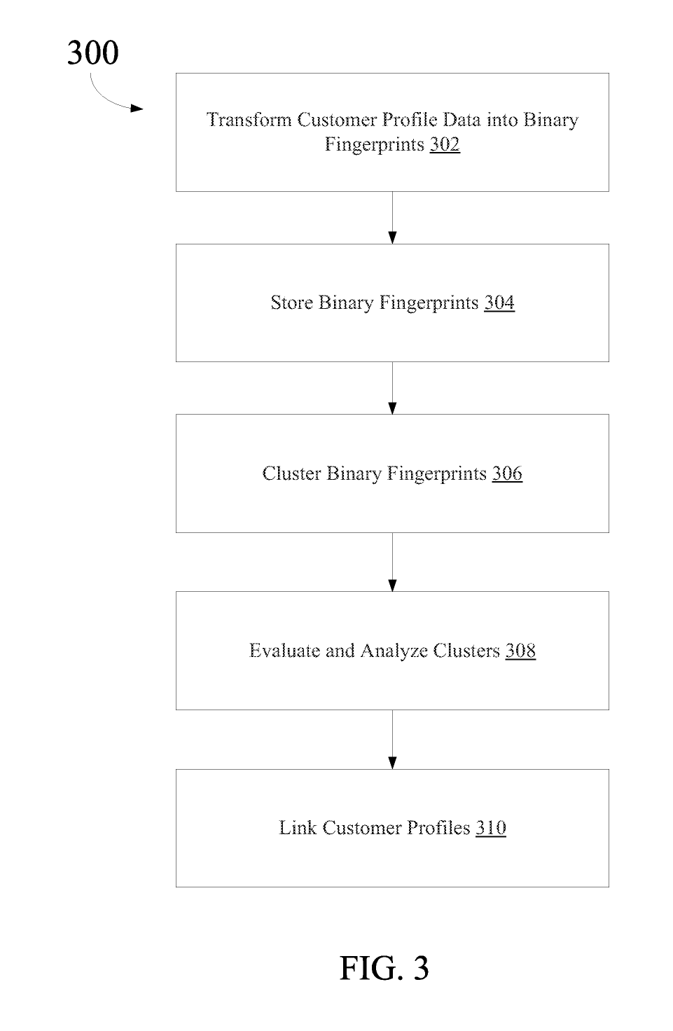

FIG. 3 shows a flow chart for a method of linking customer profiles according to an illustrative embodiment of the present invention. The method 300 comprises transforming 302 the customer profile data contained in each customer profile into binary fingerprints. The binary fingerprints comprise a set of bits wherein each bit represents a selected portion of information contained in the customer profile. An illustrative method of transforming the customer profile data into sets of bits is through use of trigrams, which will be described more fully below. Other methods of transforming text data into numerical data are known in the art and could be used according to the principles set forth in this disclosure.

After the customer profile data are transformed into binary fingerprints, i.e., bit sets, the binary fingerprints may be stored 304 in a binary fingerprint database. These binary fingerprints are clustered 306 into clusters according to the similarity in the binary fingerprints. An illustrative method of clustering similar binary fingerprints is by means of methods well known in the field of chemical structure analysis. According to this known methodology, chemical structures are compared to each other by comparing bit sets, that is, without the need to draw representations of chemical structures and compare these representations themselves. In the present case, customer profiles are compared to other customer profiles by comparing bit sets without the need to compare the customer profiles themselves. This approach is based on the concept that similar customer profiles have similar bit sets. An illustrative example of this clustering process is by means of what is known as fuzzy clustering, which is well known and well described in the literature of chemical structure comparisons. Other clustering methodologies are known in the art and may be used in accordance with the principles described herein.

After the binary fingerprints are clustered into clusters, whether by fuzzy clustering or other clustering methodology, the clusters may be evaluated 308 and analyzed. As mentioned above, for some purposes the company may want to be very certain that selected clustered fingerprints, and thus the associated customer profiles, belong to the same person. For other purposes, it may not necessarily be important to determine that selected clustered fingerprints represent the same person. Statistical analyses can be conducted such that a selected confidence level may be used to make determinations of whether or not clustered fingerprints belong to the same person. After evaluating clusters, customer profiles may be linked 310. For example, if the evaluation and analysis process results in a determination that two or more customer profiles are so similar that the associated customers are likely to a selected confidence level to be the same customer or the same household, then the relevant customer profiles may be linked to each other, thereby reducing the redundancy of the customer profile database.

An illustrative method of transforming information contained in a customer data profile to bit sets will now be described. The result of this transformation is to convert text data into bit sets. Consider a customer profile that comprises a name, which may include first, middle, and last names, as well as honorifics; an address, which may comprise the current address as well as previous addresses; telephone number, which may include current and former telephone numbers for home, work, cell, and the like; and email addresses, which may also include current and former email addresses for home, work, and the like. Each such record can be converted to (perhaps multiple) standard and transformed representations of each element, where transformations include the well-known Soundex and similar transformations, as well as simple typographical errors, such as character transpositions. Other transformations may include recognition of nicknames, such as “Richard” becoming “Dick.”

Each resulting set of strings of text data for a profile can be converted to a set of trigrams, i.e., sets of three successive letters. Given that letters (lower case only), numbers, and a few punctuation characters may be used, there are roughly 50×50×50 such possible trigrams, or 125,000 of them. In particular instances, other numbers of trigrams may be used, as will be illustrated in Example 1 below. Each trigram from each element of the customer profile (name, address, etc.) is assigned by optical character recognition into a blank bit set of 125,000 possible bits representing the presence (1) or absence (0) of each possible trigram. Given the representation of a customer profile as one or more bit sets, a large set of well-known operations is available to find all potential matches, those that have a high enough Tanimoto or Jaccard similarity of bits in common, and to cluster all customers based on such bit sets.

It will be appreciated that a large bit set, such as one containing 125,000 dimensions as described in the previous paragraph, cannot reasonably be reverse-transformed to reproduce the data that comprised the customer profile. Thus, if an unauthorized person were to obtain access to the binary fingerprint database, the likelihood of being able to extract customer profile information from the bit sets would be exceedingly small. Therefore, the security advantage surrounding the use of binary fingerprint databases is considerable.

### Example 1

In this example, four profiles will be considered with the following information for name, address, and email address:
Profile 1: ‘John Doe’, ‘1234 Main St.’, ‘Springfield, Mass. 91033’, ‘jdoe23@yahoo.com’
Profile 2: ‘David Jackson’, 571 Spruce Ave.′, ‘Dumont, Wis. 45322’, ‘buzzerkid@aol.com’
Profile 3: ‘David Johnson’, ‘809 Vermont Court Apt 3B’, ‘Dalton, Calif. 94555’, ‘noemail@cause.org’
Profile 4: ‘David Johnson’, ‘809 Vt Vt Apt 3B’, ‘Dalton, Calif. 9455’, ‘noemail@because.org’

These four profiles may represent three people, with the Profile 4 being a badly typed approximation of Profile 3. The trigram sets corresponding to the four profiles are constructed by taking all three-letter sequences of letters:
Trigram set for Profile 1: [‘ohn’, ‘ma’, ‘oe2’, ‘spr’, ‘.co’, ‘pri’, ‘, m’, ‘st’, ‘rin’, ‘mai’, ‘gfi’, ‘n d’, ‘234’, ‘ing’, ‘hn’, ‘ngf’, ‘d,’, ‘34’, ‘hoo’, ‘eld’, ‘@ya’, ‘a 9’, ‘iel’, ‘fie’, ‘910’, ‘yah’, ‘oo.’, ‘aho’, ‘o.c’, ‘n s’, ‘ld,’, ‘123’, ‘joh’, ‘103’, ‘4 m’, ‘in’, ‘do’, ‘jdo’, ‘ma’, ‘e23’, ‘23@’, ‘doe’, ‘3@y’, ‘ain’, ‘91’]
Trigram set for Profile 2: [‘yid’, ‘ce’, ‘571’, ‘453’, ‘pru’, ‘uce’, ‘avi’, ‘uzz’, ‘.co’, ‘, w’, ‘aye’, ‘rki’, ‘ont’, ‘dum’, ‘d@a’, ‘id@’, ‘ay’, ‘umo’, ‘kid’, ‘jac’, ‘id’, ‘buz’, ‘sp’, ‘wi’, ‘ruc’, ‘45’, ‘aol’, ‘d j’, ‘ol.’, ‘e a’, ‘day’, ‘mon’, ‘zze’, ‘@ao’, ‘kso’, ‘l.c’, ‘71’, ‘zer’, ‘i 4’, ‘ack’, ‘1 s’, ‘wi’, ‘t,’, ‘532’, ‘cks’, ‘erk’, ‘ja’, ‘spr’, ‘nt,’]
Trigram set for Profile 3: [‘ohn’, ‘yid’, ‘nso’, ‘, c’, ‘455’, ‘apt’, ‘n,’, ‘t c’, ‘avi’, ‘t a’, ‘our’, ‘09’, ‘nt’, ‘alt’, ‘rmo’, ‘ont’, ‘use’, ‘ve’, ‘co’, ‘se.’, ‘ca’, ‘hns’, ‘ap’, ‘aus’, ‘a 9’, ‘ton’, ‘.or’, ‘ca’, ‘id’, ‘t 3’, ‘rt’, ‘on,’, ‘dal’, ‘noe’, ‘@ca’, ‘d j’, ‘pt’, ‘day’, ‘9 v’, ‘mon’, ‘oem’, ‘joh’, ‘ver’, ‘il@’, ‘ema’, ‘cou’, ‘809’, ‘94’, ‘945’, ‘l@c’, ‘cau’, ‘e.o’, ‘urt’, ‘ail’, ‘jo’, ‘mai’, ‘erm’, ‘lto’]
Trigram set for Profile 4: [‘ivd’, ‘aiv’, ‘nso’, c′, ‘apt’, ‘n,’, ‘t a’, ‘se.’, ‘09’, ‘alt’, ‘e.o’, ‘.or’, ‘use’, ‘eca’, ‘ca’, ‘809’, ‘ap’, ‘vd’, ‘aus’, ‘a 9’, ‘ton’, ‘vt’, ‘ca’, ‘t 3’, ‘on,’, ‘dal’, ‘noe’, ‘dai’, ‘d j’, ‘9 v’, ‘oem’, ‘mai’, ‘ema’, ‘pt’, ‘il@’, ‘vt’, ‘t v’, ‘94’, ‘945’, ‘l@b’, ‘cau’, ‘jhn’, ‘ail’, ‘hns’, ‘jh’, ‘@be’, ‘bec’, ‘lto’]

Each such three-letter group may be converted into an integer index, for example, using the list of 46 characters below, numbered 0 to 45:
‘a’, ‘b’, ‘c’, ‘d’, ‘e’, ‘f’, ‘g’, ‘h’, ‘j’, ‘k’, ‘l’, ‘m’, ‘n’, ‘o’, ‘p’, ‘q’, ‘r’, ‘s’, ‘t’, ‘u’, ‘v’, ‘w’, ‘x’, ‘y’, ‘z’, ‘0’, ‘1’, ‘2’, ‘3’, ‘4’, ‘5’, ‘6’, ‘7’, ‘8’, ‘9’, ‘ ’, ‘,’, ‘“ ”’, ‘@’, ‘&’, ‘(‘,’)’, ‘−’, ‘+’, ‘.’

Thus, for example, the letter ‘o’ corresponds to 14 in the integer index, the letter ‘h’ corresponds to 7, and the letter ‘n’ corresponds to 13. Each trigram is shown as being present in a bit set by setting the value of the nth bit in the bit set to 1. For example, the trigram “ohn” is turned into 14×(46×46)+7×46+13=29959 and then the 29959th bit is turned to a 1 to show that it is present, with all the other 46×46×46 bits being 0 at the start. The trigram “ma” is then treated as 36×(46×46)+12×46+0=76728, and the 76728th bit is also set to 1. Each succeeding profile is treated similarly. This results in a 46×46×46=97,336-dimensional bit set in which most of the bits are set at 0 and a relatively few bits are set at 1.

The similarity between two profiles is the Tanimoto (or, equivalently, the Jaccard) similarity, measured as the number of trigrams that are in both of the two profiles divided by the number of trigrams that are in at least one of the two profiles. This is then the fraction of all trigrams in the two profiles that are shared between them.

Comparing Profiles 1-4, a computer quickly finds these similarities:

(a) Profile 1 and Profile 2 share two trigrams of a combined 92 trigrams, and the similarity is 0.022 (where 0 is completely different and 1 is identical);

(b) Profile 1 and Profile 3 share four trigrams of a combined 99 trigrams, and the similarity is 0.040;

(c) Profile 1 and Profile 4 share 2 trigrams of a combined 91 trigrams, and the similarity is 0

(d) Profile 2 and Profile 3 share 7 trigrams of a combined 100 trigrams, and the similarity is 0.070;

(e) Profile 2 and Profile 4 share 1 trigram of a combined 96 trigrams, and the similarity is 0.010; and

(f) Profile 3 and Profile 4 share 35 trigrams of a combined 71 trigrams, and the similarity is 0.493.

These results illustrate that profiles that do not match will have a low similarity (generally less than 0.100), while even badly mangled versions of the same profile will have a high similarity (roughly 0.500 and higher) using this method.

Using fuzzy clustering, the results of this example yield three “centers,” that is, three individuals, with Profile 1 and Profile 2 having 100% membership in themselves only (or nearly so), and Profile 3 and Profile 4 sharing a large but not 100% membership in a shared cluster that would, speaking very approximately, have a cluster center midway between these two profiles in the 46×46×46=97,336-dimensional space of these trigram bits.

Therefore, Profile 3 and Profile 4 could be linked to each other because the profiles appear to represent the same person.

The foregoing description has been presented for the purposes of illustration and description. It is not intended to be exhaustive or to limit the disclosure to the precise form disclosed. Many modifications and variations are possible in light of the above teaching Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for linking customer profiles contained in a customer profile database, the method comprising:
with a processor, transforming data associated with each of said customer profiles into a binary fingerprint and storing each said binary fingerprint in a binary fingerprint database comprising a plurality of binary fingerprints;
with a processor, clustering the plurality of binary fingerprints in the binary fingerprint database into clusters based on similarities among the plurality of binary fingerprints;
with a processor, evaluating the data associated with each of said binary fingerprints in each of said clusters and determining if customer profiles within each of said clusters match each other; and
with a processor, linking customer profiles when customer profiles within clusters match each other.

2. The method of claim 1, wherein the data associated with customer profiles comprise one or more of customer name, customer address, customer telephone number, customer email address, and customer credit card information.

3. The method of claim 1, wherein each said binary fingerprint comprises large, sparse sets of binary bits.

4. The method of claim 1, wherein said binary fingerprint represents the presence or absence of every possible trigram present in the corresponding customer profile.

5. The method of claim 1, wherein similarities among the plurality of binary fingerprints are determined by calculating Tanimoto or Jaccard similarities.

6. The method of claim 5, wherein a Tanimoto or Jaccard similarity of less than about 0.100 indicates that customer profiles do not match each other.

7. The method of claim 5, wherein a Tanimoto or Jaccard similarity of about 0.500 or greater indicates that customer profiles match each other.

8. The method of claim 1, wherein clustering the plurality of binary fingerprints is achieved by fuzzy clustering technology.

9. A system for linking customer profiles contained in a customer profile database comprising: one or more processors and one or more memory devices operably coupled to the one or more processors and storing executable and operational data, the executable and operational data effective to cause the one or more processors to:
transform data associated with each of said customer profiles into a binary fingerprint and store each said binary fingerprint in a binary fingerprint database comprising a plurality of binary fingerprints;
cluster the plurality of binary fingerprints in the binary fingerprint database into clusters based on similarities among the plurality of binary fingerprints;
evaluate the data associated with each of said binary fingerprints in each of said clusters and determine if customer profiles within each of said clusters match each other; and
link customer profiles when customer profiles within clusters match each other.

10. The system of claim 9, wherein the data associated with customer profiles comprise one or more of customer name, customer address, customer telephone number, customer email address, and customer credit card information.

11. The system of claim 9, wherein each said binary fingerprint comprises large, sparse sets of binary bits.

12. The system of claim 9, wherein said binary fingerprint represents the presence or absence of every possible trigram present in the corresponding customer profile.

13. The system of claim 9, wherein similarities among the plurality of binary fingerprints are determined by calculating Tanimoto or Jaccard similarities.

14. The system of claim 13, wherein a Tanimoto or Jaccard similarity of less than about 0.100 indicates that customer profiles do not match each other.

15. The system of claim 13, wherein a Tanimoto or Jaccard similarity of about 0.500 or greater indicates that customer profiles match each other.

16. The system of claim 9, wherein the step to cluster the plurality of binary fingerprints is achieved by fuzzy clustering technology.
